(19) United States
(12) Patent Application Publication
(10) Pub. No.: US 2026/0244047 A1
(43) Pub. Date: Aug. 20, 2026

(54) METHODS AND APPARATUS FOR LIGHT ATTENUATION AND HEAT MANAGEMENT USING ELECTROPHORETIC MEDIA

(71) Applicant: E INK CORPORATION, Billerica, MA (US)

(72) Inventors: Dan LUO, Lexington, MA (US); Karl Raymond AMUNDSON, Cambridge, MA (US); Yu XIA, Acton, MA (US); Stephen J. TELFER, Arlington, MA (US)

(21) Appl. No.: 19/534,091

(22) Filed: Feb. 9, 2026

Related U.S. Application Data
(60) Provisional application No. 63/758,824, filed on Feb. 14, 2025.

(51) Int. Cl. G02F 1/1333; G02F 1/167; G02F 1/1676

(52) U.S. Cl. CPC G02F 1/133385; G02F 1/167; G02F 1/1676

(57) ABSTRACT

A switchable light modulator includes an electrophoretic medium for use in a window of an enclosure (e.g., a greenhouse or other building or a vehicle) for light attenuation and heat management. The electrophoretic medium can be driven among a plurality of optical states including: (a) a first set of optical states for reducing transmittance of thermal radiation from incident sunlight through the switchable light modulator into the enclosure, (b) a second set of optical states for promoting transmittance of thermal radiation from the incident sunlight through the switchable light modulator into the enclosure, and (c) a third set of optical states for reducing transmittance of thermal radiation out of the enclosure during nighttime operation.

### CROSS REFERENCE TO RELATED APPLICATIONS

This application claims priority from U.S. Provisional Patent Application No. 63/758,824 filed on Feb. 14, 2025 entitled METHODS AND APPARATUS FOR LIGHT ATTENUATION AND HEAT MANAGEMENT USING ELECTROPHORETIC MEDIA, which is hereby incorporated by reference in its entirety.

### BACKGROUND

The present invention generally relates to electrophoretic and other electro-optic light modulating films. Light modulating films modulate the amount of light or other electro-magnetic radiation passing through an electrophoretic medium. In some instances, the light will pass completely through the film (i.e., from top to bottom). In other instances, the light may pass through the electrophoretic medium, reflect/scatter off a surface, and return through the medium a second time (i.e., from top to bottom surfaces and back to top.) In other instances, the light will be absorbed by pigment particles present at the viewing surface. In other instances, selective absorption of the light by pigment particles will result in a rendered image, e.g., text or a picture. Such films can be incorporated into displays, signs, variable transmission windows, mirrors, displays, and similar devices. Typically the films have an “open” state, in which one or more sets of pigment particles are isolated to the side or in wells, etc., so that most of the incident light can pass through the medium, and a “closed” state, in which one or more sets of pigment particles are distributed through the medium to absorb some or all of the incident light.

For example, U.S. Patent No. 10,067,398 discloses an electrophoretic light attenuator comprising a cell including a first substrate, a second substrate spaced apart from the first substrate, a layer arranged between the substrates containing an electrophoretic ink, and a monolayer of closely packed protrusions projecting into the electrophoretic ink and arranged adjacent a surface of the second substrate. The protrusions have surfaces defining a plurality of depressions between adjacent protrusions. The electrophoretic medium layer (ink layer) includes charged particles of at least one type, the particles being responsive to an electric field applied to the cell to move between a first extreme light state, in which the particles are generally maximally spread within the cell so as to lie in the path of light through the cell and thus strongly attenuate light transmitted from one substrate to the opposite substrate, and a second extreme light state, in which the particles are generally maximally concentrated within the depressions so as to let light be transmitted. The total area corresponding to the concentrated particles in the depressions is a fraction of the total face area.

Devices of this type rely at least in part on the shape of their non-planar, polymer structure to concentrate absorbing charged particles (e.g., black particles) in an electrophoretic ink in a transparent light state thereby forming (or exposing) light apertures (i.e., transmitting areas) and light obstructions (i.e., strongly absorbing areas). The present application additionally relates to more traditional electrophoretic displays, such as described in U.S. Patent Nos. 9,921,451 and 9,812,073, which modulate the light reflected at the viewing surface with the presence of charged pigment particles.

For convenience, the term "light" will normally be used herein, but this term should be understood in a broad sense to include electro-magnetic radiation at non-visible wavelengths. For example, the present invention may be applied to provide windows that can modulate infra-red radiation for controlling temperatures within buildings or vehicles. More specifically, this invention relates to light modulators that use particle-based electrophoretic media to control light modulation. Examples of electrophoretic media that may be incorporated into various embodiments of the present invention include, e.g., the electrophoretic media described in U.S. Patent Nos. 10,809,590 and 10,983,410, the contents of both of which are incorporated by reference herein in their entireties.

Prior art solutions that have a polymer structure in the fluid or gel layer suitable for use with the invention include U.S. Patent No. 8,508,695 to Vlyte Innovations Ltd., which discloses dispersing fluid droplets (1 to 5 microns in diameter) in a continuous polymer matrix that is cured in place to both substrates, to contain liquid crystals. Additionally, U.S. Patent No. 10,809,590 to E Ink Corporation discloses microencapsulating fluid droplets and deforming them to form a monolayer of close packed polymer shells in a polymer matrix on one substrate and subsequently applying an adhesive layer to bond the capsule layer to a substrate. Also, European Patent Application Publication EP1264210 to E Ink California discloses embossing a micro-cup structure on one substrate, filling the cups with fluid having polymerizable components and polymerizing the components to form a sealing layer on the fluid/cup surface, then applying an adhesive layer to bond to the second substrate. Additionally, EP2976676 to Vlyte Innovations Ltd. discloses forming a wall structure on one substrate, coating the tops of walls with adhesive, filling the cavities defined by the walls with fluid, and polymerizing the adhesive to bond the tops of walls to the opposing substrate. EP3281055 describes a flexible device including solid polymer microstructures embedded in its viewing area and the microstructures are on both substrates. The microstructures join (i.e., fasten) the substrates of the device to each other by engaging with each other over a length orthogonal to the substrates. The joined microstructures incorporate a wall structure that divides a device’s fluid layer into a monolayer of discrete volumes contained within corresponding cavities. This provides the device with significant structural strength. In the method described, mating microstructures (i.e., male and female parts) are formed on each substrate, then precisely aligned with each other and joined in a press fit that also seals the fluid layer in the cavities.

Particle-based electrophoretic displays, in which a plurality of charged particles move through a suspending fluid under the influence of an electric field, have been the subject of intense research and development for a number of years. Such displays can have attributes of good brightness and contrast, wide viewing angles, state bistability, and low power consumption when compared with liquid crystal displays. The terms "bistable" and "bistability" are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, e.g., at least four times, the minimum duration of the addressing pulse required to change the state of the display element. It is shown in U.S. Patent No. 7,170,670 that some particle-based electrophoretic displays capable of gray scale are stable not only in their extreme black and white states but also in their intermediate gray states, and the same is true of some other types of electro-optic displays. This type of display is properly called "multi-stable" rather than bistable, although for convenience the term "bistable" may be used herein to cover both bistable and multi-stable displays.

As noted above, electrophoretic media require the presence of a suspending fluid. In most prior art electrophoretic media, this suspending fluid is a liquid, but electrophoretic media can be produced using gaseous suspending fluids; see, e.g., Kitamura, T., et al., "Electrical toner movement for electronic paper-like display", IDW Japan, 2001, Paper HCS1-1, and Yamaguchi, Y, et al., "Toner display using insulative particles charged triboelectrically", IDW Japan, 2001, Paper AMD4-4). See also European Patent Applications 1,429,178; 1,462,847; and 1,482,354; and International Applications WO 2004/090626; WO 2004/079442; WO 2004/077140; WO 2004/059379; WO 2004/055586; WO 2004/008239; WO 2004/006006; WO 2004/001498; WO 03/091799; and WO 03/088495. Such gas-based electrophoretic media appear to be susceptible to the same types of problems due to particle settling as liquid-based electrophoretic media, when the media are used in an orientation that permits such settling, e.g., in a sign where the medium is disposed in a vertical plane. Indeed, particle settling appears to be a more serious problem in gas-based electrophoretic media than in liquid-based ones since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation, E Ink California, LLC, and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:
(a) Electrophoretic particles, fluids and fluid additives; see, e.g., U.S. Patent No. 7,002,728;
(b) Capsules, binders and encapsulation processes; see, e.g., U.S. Patent Nos. 6,922,276 and 7,411,719;
(c) Microcell structures, wall materials, and methods of forming microcells; see, e.g., U.S. Patent Nos. 7,072,095 and 9,279,906;
(d) Methods for filling and sealing microcells; see, e.g., U.S. Patents No. 7,715,088 and U.S. Patent Application Publication No. 2002/0188053;
(e) Films and sub-assemblies containing electro-optic materials; see, e.g., U.S. Patent Nos. 6,982,178 and 7,839,564;
(f) Backplanes, adhesive layers and other auxiliary layers and methods used in displays; see, e.g., U.S. Patent Nos. 7,116,318 and 7,535,624;
(g) Color formation and color adjustment, see e.g., U.S. Patent Nos. 7,075,502 and 7,839,564;
(h) Methods for driving displays; see, e.g., U.S. Patent Nos. 7,012,600 and 7,453,445;
(i) Applications of displays; see, e.g., U.S. Patent Nos. 7,312,784 and 8,009,348; and
(j) Non-electrophoretic displays, as described in U.S. Patent No. 6,241,921 and U.S. Patent Applications Publication No. 2015/0277160; and applications of encapsulation and microcell technology other than displays; see, e.g., U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see, e.g., the aforementioned U.S. Patent Application Publication No. 2002/0131147. Accordingly, for purposes of the present application, such polymer-dispersed electrophoretic media are regarded as sub-species of encapsulated electrophoretic media.

A related type of electrophoretic display is a so-called "microcell electrophoretic display". In a microcell electrophoretic display, the charged particles and the suspending fluid are not encapsulated within microcapsules but instead are retained within a plurality of cavities formed within a carrier medium, typically a polymeric film. See, e.g., International Application Publication No. WO 02/01281, and published U.S. Application Publication No. 2002/0075556, both assigned to SiPix Imaging, Inc.

Electrophoretic media are often opaque (since, e.g., in many electrophoretic media, the particles substantially block transmission of visible light through the display) and operate in either a light-absorptive or a light-reflective mode. However, electrophoretic devices can also be made to operate in a so-called “shutter mode,” in which one display state is substantially opaque, and one is substantially light-transmissive. See, e.g., the aforementioned U.S. Patent Nos. 6,130,774 and 6,172,798, and U.S. Patent Nos. 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Patent No. 4,418,346. Other types of electro-optic displays may also be capable of operating in shutter mode. In particular, when this “shutter mode” electrophoretic device is constructed on a transparent substrate, it is possible to regulate transmission of light through the device.

An encapsulated or microcell electrophoretic display typically does not suffer from the clustering and settling failure mode of traditional electrophoretic devices and provides further advantages, such as the ability to print or coat the display on a wide variety of flexible and rigid substrates. (Use of the word "printing" is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques.) Thus, the resulting display can be flexible. Further, because the display medium can be printed (using a variety of methods), the display itself can be made inexpensively.

One potentially important market for electrophoretic media is windows with variable light transmission. As the energy performance of buildings becomes increasingly important, electrophoretic media can be used as coatings on windows to enable the proportion of incident radiation transmitted through the windows to be electronically controlled by varying the optical state of the electrophoretic media. Effective implementation of such "variable-transmissivity" ("VT") technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile or other vehicle, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

A need exists for a VT switchable light modulator for use in windows of buildings and vehicles that can be actively controlled for effective light attenuation and heat management under various conditions including when it is desired to reduce thermal radiation transmittance into interior spaces as well as where transmittance is favored.

### SUMMARY

A switchable light modulator according to a first aspect of the invention is disclosed for use in a window of an enclosure for light attenuation and heat management. The switchable light modulator includes a first light-transmissive substrate for receiving incident sunlight, a first electrode layer on one side of the first light-transmissive substrate, a second light-transmissive substrate, a second electrode layer on one side of the second light-transmissive substrate, and a light-transmissive polymer structure between the first electrode layer and the second electrode layer. The light-transmissive polymer structure includes a base superposed on the second electrode layer and a wall structure extending orthogonally from the base defining a plurality of cells. Each of the plurality of cells includes a plurality of wells in the base. An electrophoretic medium is contained in each of the plurality of cells. The electrophoretic medium comprises a plurality of charged reflective pigment particles and a plurality of charged absorptive pigment particles dispersed in a non-polar solvent. A controller is configured to apply a set of driving voltages between the first and second electrodes to drive the electrophoretic medium among a plurality of optical states including: (a) a first set of optical states for reducing transmittance of thermal radiation from the incident sunlight through the switchable light modulator into the enclosure by spreading the plurality of charged reflective pigment particles across each cell proximate the first electrode layer and positioning the plurality of charged absorptive pigment particles between the plurality of charged reflective pigment particles and the second electrode layer in varying arrangements to achieve open, tinted, and closed states, (b) a second set of optical states for promoting transmittance of thermal radiation from the incident sunlight through the switchable light modulator into the enclosure by concentrating the plurality of charged reflective pigment particles in the wells in the polymer structure and positioning the plurality of charged absorptive pigment particles between the plurality of charged reflective pigment particles and the first electrode layer in varying arrangements to achieve open and tinted states, and (c) a third set of optical states for reducing transmittance of thermal radiation out of the enclosure during nighttime operation by spreading the plurality of charged reflective pigment particles across each cell and spreading the plurality of charged absorptive pigment particles across each cell between the plurality of charged reflective pigment particles and the first electrode layer.

A method according to a second aspect of the invention comprises providing a switchable light modulator for use in a window of an enclosure for light attenuation and heat management, comprising a first light-transmissive substrate for receiving incident sunlight; a first electrode layer on one side of the first light-transmissive substrate; a second light-transmissive substrate; a second electrode layer on one side of the second light-transmissive substrate; a light-transmissive polymer structure between the first electrode layer and the second electrode layer, the light-transmissive polymer structure including a base superposed on the second electrode layer and a wall structure extending from the base defining a plurality of cells, each of the plurality of cells including a plurality of wells in the base; and an electrophoretic medium contained in each of the plurality of cells, said electrophoretic medium comprising a plurality of charged reflective pigment particles and a plurality of charged absorptive pigment particles dispersed in a non-polar solvent. The method comprises applying a set of driving voltages between the first and second electrodes to drive the electrophoretic medium among a plurality of optical states including: (a) a first set of optical states for reducing transmittance of thermal radiation from the incident sunlight through the switchable light modulator into the enclosure by distributing the plurality of charged reflective pigment particles across each cell proximate the first electrode layer and positioning the plurality of charged absorptive pigment particles between the plurality of charged reflective pigment particles and the second electrode layer in varying arrangements to achieve open, tinted, and closed states, (b) a second set of optical states for promoting transmittance of thermal radiation from the incident sunlight through the switchable light modulator into the enclosure by concentrating the plurality of charged reflective pigment particles in the wells in the polymer structure and positioning the plurality of charged absorptive pigment particles between the plurality of charged reflective pigment particles and the first electrode layer in varying arrangements to achieve open and tinted states, and (c) a third set of optical states for reducing transmittance of thermal radiation out of the enclosure during nighttime by distributing the plurality of charged reflective pigment particles across each cell and positioning the plurality of charged absorptive pigment particles between the plurality of charged reflective pigment particles and the first electrode layer.

In one or more embodiments, the first set of optical states includes: (i) a first open state, in which the plurality of charged absorptive particles are concentrated in the wells in the polymer structure to increase transmittance of visible light from the incident sunlight through the switchable light modulator, and the plurality of charged reflective pigment particles are distributed across each cell proximate the first electrode layer to reduce transmittance of thermal radiation from the incident sunlight through the switchable light modulator, (ii) a first tinted state, in which the plurality of charged absorptive particles are positioned in or proximate to the wells in the polymer structure in a less concentrated arrangement than the charged absorptive particles in the first open state to partially block transmittance of visible light from the incident sunlight through the switchable light modulator, and the plurality of charged reflective pigment particles are distributed across each cell proximate the first electrode layer to reduce transmittance of thermal radiation from the incident sunlight through the switchable light modulator, and (iii) a first closed state, in which the plurality of charged absorptive particles and the plurality of charged reflective pigment particles are distributed across each cell, with the layer of the plurality of charged reflective pigment particles positioned between the layer of the plurality of charged absorptive particles and the first electrode layer, to reduce transmittance of the incident sunlight through the switchable light modulator.

In one or more embodiments, the second set of optical states includes: (i) a second open state, in which the plurality of charged absorptive particles and the plurality of charged reflective pigment particles are concentrated in the wells in the polymer structure to increase transmittance of visible light and thermal radiation from the incident sunlight through the switchable light modulator, and (ii) a second tinted state, in which the plurality of charged absorptive particles are positioned in or proximate to the wells in the polymer structure in a less concentrated arrangement than the charged absorptive particles in the second open state to partially block transmittance of visible light from the incident sunlight through the switchable light modulator, and the plurality of charged reflective pigment particles are concentrated in the wells in the polymer structure to increase transmittance of thermal radiation from the incident sunlight through the switchable light modulator.

In one or more embodiments, the third set of optical states includes a second closed state, in which a layer of the plurality of charged absorptive particles and a layer of the plurality of charged reflective pigment particles are distributed across each cell, with the layer of the plurality of charged absorptive particles positioned between the layer of the plurality of charged reflective pigment particles and the first electrode layer, to reduce transmittance of thermal radiation out of the enclosure through the switchable light modulator.

In one or more embodiments, a sealing layer is applied over the polymer structure to seal the electrophoretic medium in the plurality of cells.

In one or more embodiments, the plurality of charged reflective pigment particles can be arranged in the cells to reflect 20–60% of the incident sunlight.

In one or more embodiments, the enclosure comprises a building (e.g., a greenhouse) or a vehicle.

In one or more embodiments, the switchable light modulator comprises a film superposed on the window.

In one or more embodiments, the charged absorptive pigment particles are black.

In one or more embodiments, the charged reflective pigment particles are white, brown, red, green, orange, yellow, violet, or purple.

In one or more embodiments, the set of driving voltages for driving the electrophoretic medium to one of the first set of optical states comprises a series of alternating positive and negative voltage pulses repeated a plurality of times, the positive pulses having an amplitude of 100 V to 200 V and a pulse width of 5 to 10 ms, and the negative pulses having an amplitude of -100 to -200 V and a pulse width of 90 to 95 ms.

In one or more embodiments, the set of driving voltages for driving the electrophoretic medium to one of the first set of optical states comprises a series of alternating positive and negative voltage pulses repeated a plurality of times with a negative bias voltage.

In one or more embodiments, the series of alternating positive and negative voltage pulses has a frequency of 10 Hz to 80 Hz, and wherein the positive and negative voltage pulses decrease in amplitude from the beginning to the end of the series of pulses.

In one or more embodiments, the set of driving voltages to drive the electrophoretic medium to an open state of the second set of optical states comprises a positive drive voltage pulse to draw the charged reflective pigment particles into the wells followed by a series of negative, low-amplitude voltage pulses to draw the charged absorptive pigment particles into the wells such that the charged reflective pigment particles are positioned between the charged absorptive pigment particles and the second electrode layer.

In one or more embodiments, the set of driving voltages to drive the electrophoretic medium to a tinted state of the second set of optical states comprises a positive drive voltage pulse to draw the charged reflective pigment particles into the wells followed by a series of negative, low-amplitude voltage pulses to draw the charged absorptive pigment particles into the wells such that the charged reflective pigment particles are positioned between the charged absorptive pigment particles and the second electrode layer, followed by a positive voltage pulse to push some, but not all of the charged absorptive pigment particles out of the wells.

These and other aspects of the present invention will be apparent in view of the following description.

### BRIEF DESCRIPTION OF THE DRAWINGS

Embodiments of the invention will now be described, by way of example, with reference to the accompanying drawings, in which:

FIG. 1 is a simplified diagram illustrating an exemplary switchable electrophoretic light modulator.

FIG. 2A is a perspective view of a portion of one example of a prior art polymer structure forming part of an electrophoretic ink layer of the switchable light modulator.

FIG. 2B is a simplified cross-sectional view of a portion of the light modulator with the polymer structure of FIG. 2A showing the device in a “closed” state in which the charged pigment particles are distributed across the cells of the device and absorb incident light.

FIG. 2C is a simplified cross-sectional view of a portion of the light modulator in an “open” state in which the charged pigment particles concentrate in wells of the polymer structure of the device.

FIGS. 4A and 4B are perspective views of a portion of another example of a prior art polymer structure forming part of an electrophoretic ink layer of the switchable light modulator.

FIGS. 5A, 5B, and 5C are simplified cross-sectional views of a portion of a switchable light modulator in accordance with one or more embodiments in open, partially open, and closed states, respectively, and configured to reduce indoor heating induced by incident sunlight.

FIGS. 6A, 6B, and 6C are simplified cross-sectional views of a portion of the switchable light modulator in accordance with one or more embodiments in another set of open, partially open, and closed states, respectively. FIGS. 6A and 6B show optical states when heating of the interior space is by sunlight is desired. FIG. 6C shows a closed optical state for reducing transmittance of thermal radiation out of the interior space, e.g., during nighttime operation.

FIG. 7 is a drawing illustrating a greenhouse including switchable light modulators in accordance with one or more embodiments applied to the greenhouse windows.

FIG. 8 is a graph illustrating one example of response characteristics of one type of charged pigment particles to drive schemes with different duty cycles

The drawings depict one or more implementations in accord with the present concepts, by way of example only, not by way of limitations.

### DETAILED DESCRIPTION

Various embodiments disclosed herein relate to a switchable light modulator for use in a window of a building (e.g., a greenhouse), a vehicle, or other enclosure for light attenuation and heat management. The switchable light modulator can be incorporated into a light control device to selectively modify light transmission and attenuation in response to electrical signals, and switches to provide a plurality of different light states. In one or more embodiments, a first light state is transparent to visible light and corresponds to a maximum light transmission – a first extreme, i.e., open state, and a second light state corresponds to a minimum transmission – a second extreme, i.e., closed state. Intermediate states are also possible, known as gray levels. Additionally, depending upon the electrophoretic medium pigment loading, a closed state may not be completely opaque, and an open state may not be completely transparent.

The switchable light modulator utilizes an electro-optic medium such as an electrophoretic ink. The electrophoretic ink comprises colored, charged particles in a suspending fluid and is in contact with the surface of a non-planar, polymer structure. The colored, charged particles can be any color, including black or white. Preferably, the suspending fluid is transparent, and refractive index matches the transparent, non-planar, polymer structure for at least one wavelength in the visible spectrum (typically 550 nm), and is a match or near match (i.e., within 0.01) for other visible light wavelengths. Consequently, in the absence of the colored charged particles, visible light rays (for the matched wavelength) experience negligible refraction at the interface between the suspending fluid and the non-planar, polymer structure.

Additionally, the charged pigment particles may be functionalized with surface polymers to improve state stability. Such pigments are described, e.g., in U.S. Patent No. 9,921,451, which is incorporated by reference in its entirety. For example, if the charged particles are of a white color, they may be formed from an inorganic pigment such as TiO₂, ZrO₂, ZnO, Al₂O₃, Sb₂O₃, BaSO₄, PbSO₄ or the like. They may also be polymer particles with a high refractive index (>1.5) and of a certain size (>100 nm) to exhibit a white color, to be substantially light-transmissive, or composite particles engineered to have a desired index of refraction. Such particles may include, e.g., poly(pentabromophenyl methacrylate), poly(2-vinylnapthalene), poly(naphthyl methacrylate), poly(alphamethylstyrene), poly(N-benzyl methacrylamide) or poly(benzyl methacrylate). Black charged particles may be formed from CI pigment black 26 or 28 or the like (e.g., manganese ferrite black spinel or copper chromite black spinel) or carbon black. Other colors (non-white and non-black) may be formed from organic pigments such as CI pigment PR 254, PR122, PR149, PG36, PG58, PG7, PB28, PB15:3, PY83, PY138, PY150, PY155 or PY20. Other examples include Clariant Hostaperm Red D3G 70-EDS, Hostaperm Pink E-EDS, PV fast red D3G, Hostaperm red D3G 70, Hostaperm Blue B2G-EDS, Hostaperm Yellow H4G-EDS, Novoperm Yellow HR-70-EDS, Hostaperm Green GNX, BASF Irgazine red L 3630, Cinquasia Red L 4100 HD, and Irgazin Red L 3660 HD; Sun Chemical phthalocyanine blue, phthalocyanine green, diarylide yellow or diarylide AAOT yellow. Color particles can also be formed from inorganic pigments, such as CI pigment blue 28, CI pigment green 50, CI pigment yellow 227, and the like. The surface of the charged particles may be modified by known techniques based on the charge polarity and charge level of the particles required, as described in U.S. Patent Nos. 6,822,782, 7,002,728, 9,366,935, and 9,372,380 as well as U.S. Patent Application Publication No. 2014-0011913, the contents of all of which are incorporated herein by reference in their entireties.

The particles may exhibit a native charge, or may be charged explicitly using a charge control agent, or may acquire a charge when suspended in a solvent or solvent mixture. Suitable charge control agents are well known in the art; they may be polymeric or non-polymeric in nature or may be ionic or non-ionic. Examples of charge control agents include, but are not limited to, Solsperse 17000 (active polymeric dispersant), Solsperse 9000 (active polymeric dispersant), OLOA® 11000 (succinimide ashless dispersant), Unithox 750 (ethoxylates), Span 85 (sorbitan trioleate), Petronate L (sodium sulfonate), Alcolec LV30 (soy lecithin), Petrostep B100 (petroleum sulfonate) or B70 (barium sulfonate), Aerosol OT, polyisobutylene derivatives or poly(ethylene co-butylene) derivatives, and the like. In addition to the suspending fluid and charged pigment particles, internal phases may include stabilizers, surfactants and charge control agents. A stabilizing material may be adsorbed on the charged pigment particles when they are dispersed in the solvent. This stabilizing material keeps the particles separated from one another so that the variable transmission medium is substantially non-transmissive when the particles are in their dispersed state.

As is known in the art, dispersing charged particles (typically a carbon black, as described above) in a solvent of low dielectric constant may be assisted by the use of a surfactant. Such a surfactant typically comprises a polar "head group" and a non-polar "tail group" that is compatible with or soluble in the solvent. The non-polar tail group may be a saturated or unsaturated hydrocarbon moiety, or another group that is soluble in hydrocarbon solvents, such as, e.g., a poly(dialkylsiloxane). The polar group may be any polar organic functionality, including ionic materials such as ammonium, sulfonate or phosphonate salts, or acidic or basic groups. Particularly preferred head groups are carboxylic acid or carboxylate groups. In some embodiments, dispersants, such as polyisobutylene succinimide and/or sorbitan trioleate, and/or 2-hexyldecanoic acid are added.

The dispersion may contain one or more stabilizers. Stabilizers suitable for use in the dispersions made according to the various embodiments disclosed herein include, but are not limited to, polyisobutylene and polystyrene. However, only a relatively low concentration of stabilizer may be necessary. A low concentration of stabilizer may assist in maintaining the media in the closed (opaque) or intermediate state, but the size of the hetero-agglomerates of the oppositely charged particles in the open state would be effectively stable without the presence of a stabilizer. For example, the dispersions incorporated in various embodiments may contain, with increasing preference in the amounts listed, less than or equal to 10%, 9%, 8%, 7%, 6%, 5%, 4%, 3%, 2%, and 1% stabilizer based on the weight of the dispersion. In some embodiments, the dispersion may be free of stabilizer.

The fluids used in the variable transmission media in various embodiments will typically be of low dielectric constant (preferably less than 10 and desirably less than 3). The fluids are preferably solvents that have low viscosity, relatively high refractive index, low cost, low reactivity, and low vapor pressure/high boiling point. The fluids are preferably light transmissive and may or may not have an optical property, such as color (e.g., red, green, blue, cyan, magenta, yellow, white, and black), that differs from the optical properties of at least one of the sets of charged particles of the dispersion. Examples of solvents include, but are not limited to, aliphatic hydrocarbons such as heptane, octane, and petroleum distillates such as Isopar ® (Exxon Mobil) or Isane® (Total); terpenes such as limonene, e.g., l-limonene; and aromatic hydrocarbons such as toluene. A particularly preferred solvent is limonene, since it combines a low dielectric constant (2.3) with a relatively high refractive index (1.47). The index of refraction of the internal phase may be modified with the addition of the index matching agents. For example, the aforementioned U.S. Patent No. 7,679,814 describes an electrophoretic medium suitable for use in a variable transmission device in which the fluid surrounding the electrophoretic particles comprises a mixture of a partially hydrogenated aromatic hydrocarbon and a terpene, a preferred mixture being d-limonene and a partially hydrogenated terphenyl, available commercially as Cargille® 5040 from Cargille-Sacher Laboratories, 55 Commerce Rd, Cedar Grove N.J. 07009. In the encapsulated media made according to various embodiments of the present invention, it is preferred that the refractive index of the encapsulated dispersion match as closely as possible to that of the encapsulating material to reduce haze. In most instances, it is beneficial to have an internal phase with an index of refraction between 1.51 and 1.57 at 550 nm, preferably about 1.54 at 550 nm. In embodiments using a light-transmissive particle that is index matched to the internal phase, the light-transmissive particle will also have an index of refraction between 1.51 and 1.57 at 550 nm, preferably about 1.54 at 550 nm.

In one or more embodiments, the encapsulated fluid may comprise one or more nonconjugated olefinic hydrocarbons, preferably cyclic hydrocarbons. Examples of nonconjugated olefinic hydrocarbons include, but are not limited to, terpenes, such as limonene; phenyl cyclohexane; hexyl benzoate; cyclododecatriene; 1,5-dimethyl tetralin; partially hydrogenated terphenyl, such as Cargille® 5040; phenylmethylsiloxane oligomer; and combinations thereof. A most preferred composition for the encapsulated fluid according to some embodiments comprises cyclododecatriene and a partially hydrogenated terphenyl.

In one or more embodiments, the amount of stabilizing agent included in the encapsulated fluid may be lower than is traditionally used in electrophoretic displays. See, for contrast, U.S. Patent No. 7,170,670. Such stabilizing agents may be large molecular weight free polymers such as polyisobutylene, polystyrene, or poly(lauryl)methacrylate. Accordingly, in some embodiments, the encapsulated fluid (i.e., dispersion) further comprises less than 10% of a stabilizing agent by weight of the dispersion. In some embodiments, the dispersion is free of the stabilizing agent. It is found that by reducing the presence of large molecular-weight polymers, the haze is improved, making the final product more pleasing.

In the open state, the charged particles respond to an electrical field applied to the electrodes to concentrate in volumes defined by the transparent, non-planar, polymer structure.

In some embodiments, the electrophoretic medium is bistable in that the medium can maintain a desired optical state without the application of an electric field. For example, when apertures or obstructions of the open state are bistable, power can be removed completely (i.e., zero volts between the first and second electrodes) after switching, and the apertures or obstructions remain unchanged. Similarly, the absence of apertures in the closed state is stable after switching and removal of power.

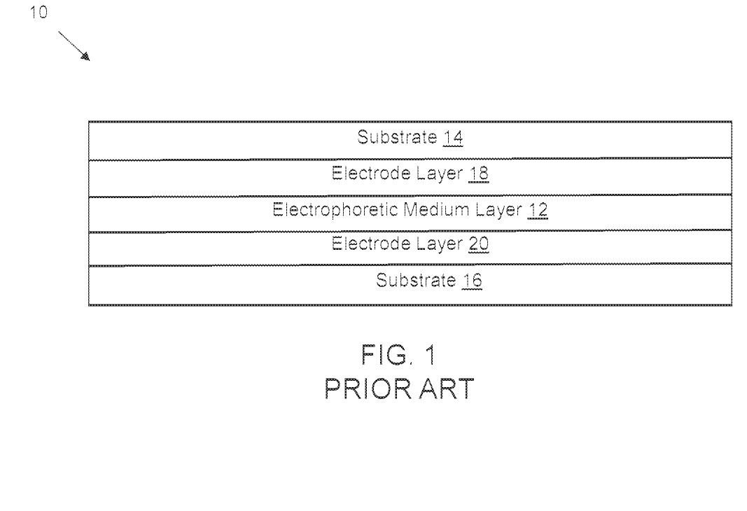

FIG. 1 is a simplified diagram illustrating an exemplary switchable electrophoretic light modulator 10. The light modulator 10 includes an electrophoretic medium layer 12 positioned between a first light-transmissive substrate 14 and a second light-transmissive substrate 16. The major surfaces of the first and second light-transmissive substrates 14, 16 face each other and are juxtaposed parallel.

The first light-transmissive substrate 14 and the second light-transmissive substrate 16 may comprise polymers including acrylate, methacrylate, vinylbenzene, vinylether, or multifunctional epoxides.

A first transparent electrode layer 18 is disposed between the first light-transmissive substrate 14 and the electrophoretic medium layer 12. A second transparent electrode layer 20 is disposed between the second light-transmissive substrate 16 and the electrophoretic layer 12. The electrode layers 18, 20 may each comprise a transparent flexible Polyethylene Terephthalate (PET) film covered on its inner face with a transparent, flexible Indium Tin Oxide (ITO) electrode.

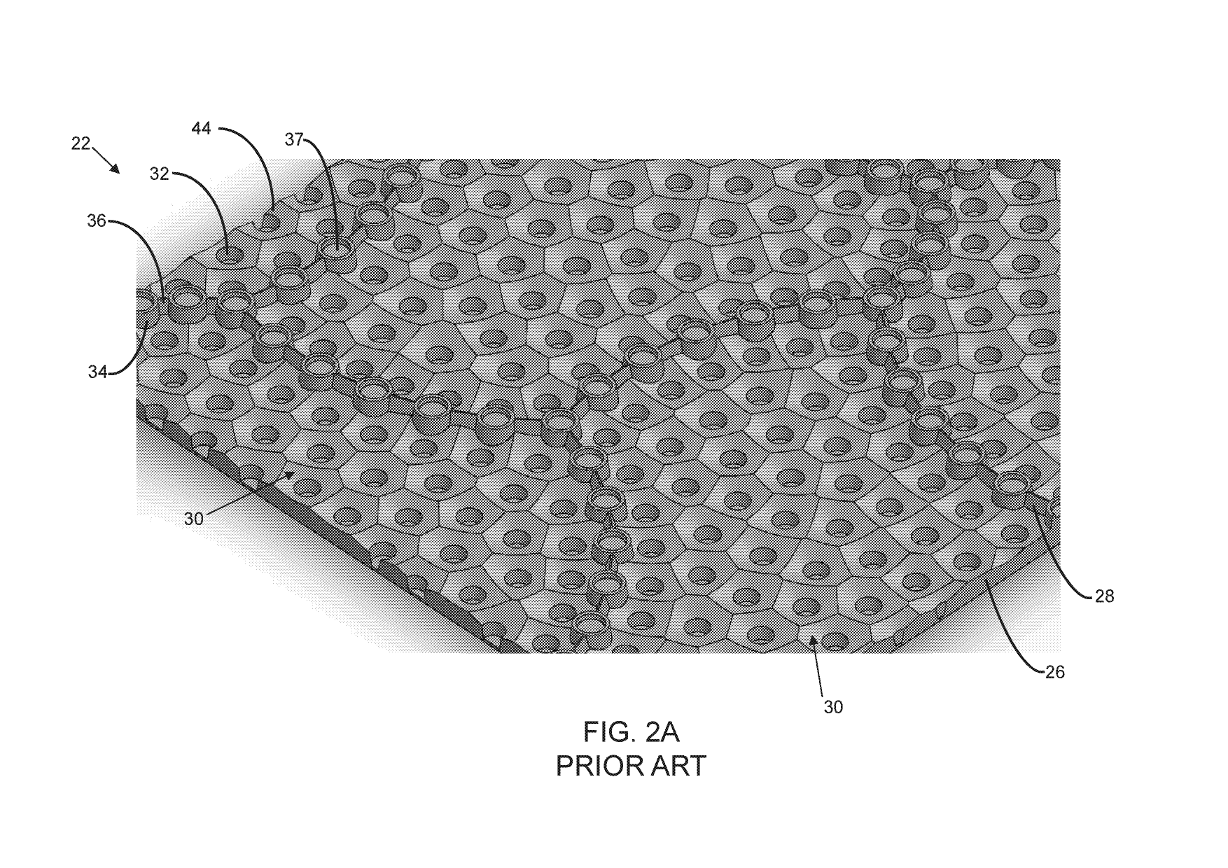

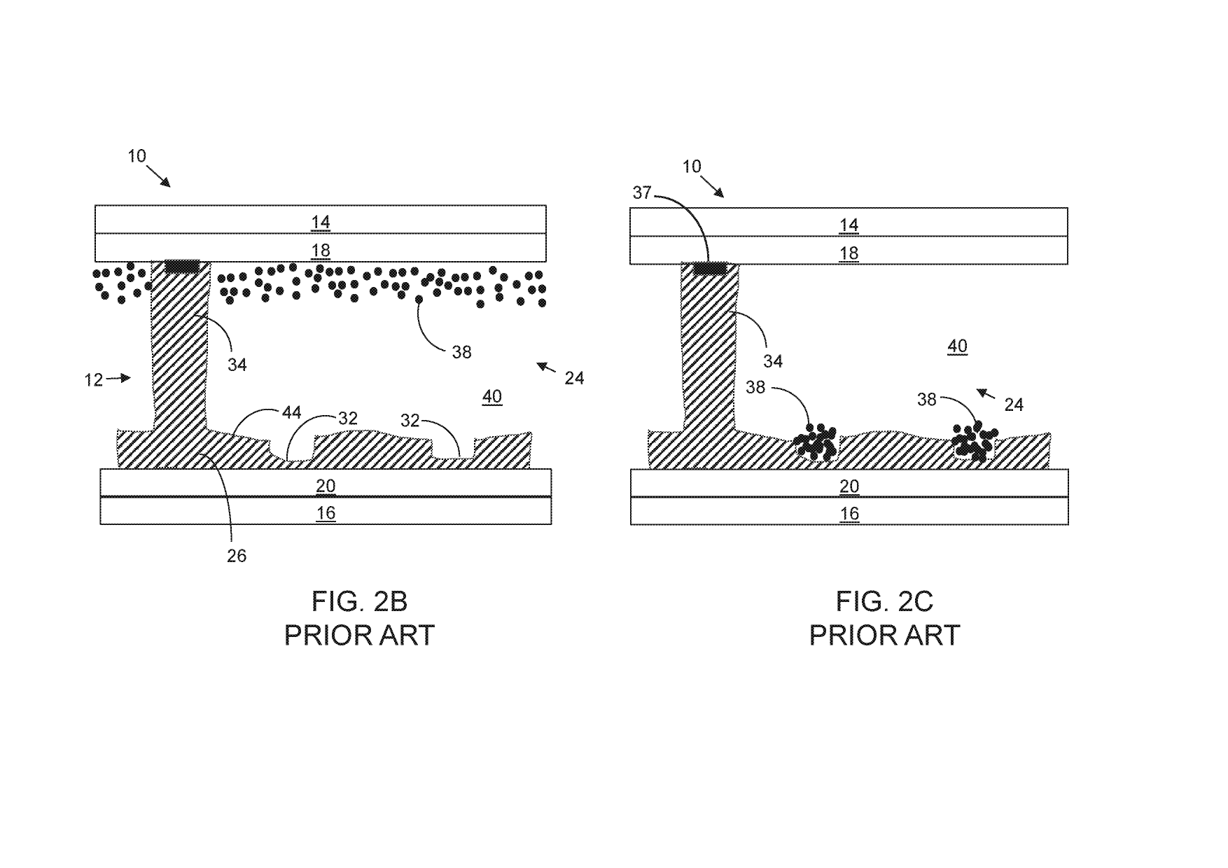

The electrophoretic layer 12 includes a light-transmissive polymer structure on the electrode layer 20. The light-transmissive polymer structure may comprise, e.g., the polymer structure 22 depicted in FIG. 2A (or the polymer structure depicted in FIG. 3A). An electro-optic medium 24 is contained in cells 30 defined by the polymer structure 22. The polymer structure 22 may be formed in an embossing process.

FIGS. 2B and 2C depict operation of a light modulator having the polymer structure 22 depicted in FIG. 2A. The electro-optic medium 24 in the electrophoretic layer 12 comprises charged pigment particles 38 dispersed in a suspending fluid (e.g., a non-polar solvent) 40. The charged particles 38 move through the suspending fluid 40 under the influence of an electric field. Applying a driving voltage between the first and second electrodes 18, 20 causes the electro-optic medium 24 to switch between a first light-absorbing closed state (FIG. 2B) and a second light-transmissive open state (FIG. 2C).

As shown in FIG. 2A, the polymer structure 22 includes a base 26 and a wall structure 28 extending orthogonally from one surface of the base 26. The wall structure 28 defines multiple cells or volumes 30 for receiving and compartmentalizing the electro-optic medium 24. The base 26 of the polymer structure 22 includes a plurality of wells 32 distributed across each of the cells 30 for receiving and concentrating charged pigment particles 38, thereby limiting the space occupied by the particles 38 in the second light-transmissive state (FIG. 2C). The base 26 includes tapered surfaces 44 leading to each of the wells 32 to promote movement of the particles 38 into the wells 32 in the second light-transmissive state.

The wall structure 28 formed on the base 26 includes a plurality of pillar structures 34 and linking wall elements 36 connecting adjacent pillar structures 34. The pillar structures 34 each include a distal surface 37 parallel to the base 26. The distal surfaces 37 are preferably similar in size and shape to the plurality of wells 32. The distal surfaces 37 of the pillar structures 34 are blackened (or otherwise colored) to resemble the wells 32 of the polymer structure 22 when filled with pigment particles 38 in the second light-transmissive state.

FIG. 2B is a simplified cross-sectional view of a portion of the light modulator unit 10 in the dark (closed) state, in which the charged pigment particles 38 in the electro-optic medium 24 are spread across the viewing face and adjacent to the inner face of the electrode layer 18. The charged pigment particles 38 absorb light incident on the unit 10.

FIG. 2C shows the light modulator unit 10 in the open state, in which the charged pigment particles 38 are concentrated in the wells 32 of the polymer structure 22.

The open state forms when a voltage having the opposite polarity to that of the charged particles 38 is applied to the electrode 20 on the substrate 16 to form an electrical field between the opposing electrodes 18, 20. The electrical field drives the charged particles 38 toward the inner face of the substrate 16 and, on encountering the tapered surfaces 44, the particles 38 migrate to and concentrate in the wells 32. The depth of the wells 32 is sufficient to hold the concentrated particles 38 in the open state. It is dependent on the volume needed by the particles 38 to concentrate, and in turn is dependent on the particle loading in the ink’s suspending fluid. The latter determines the light transmission in the dark state. The closed state (FIG. 2B) forms when the polarity of the voltage is reversed, attracting the charged particles 38 to the inner face of the substrate 14 where they spread adjacent its electrode 18. The forming of light states in an electrophoretic device using protrusions is described in more detail in the Applicant’s U.S. Patent No. 10,067,398 titled “An Electrophoretic Device Having a Transparent Light State”. The charged particles 38 may be driven with time-varying voltages, e.g., waveforms that may range in voltage from 0 to ±500V, although typically less.

The electro-optic medium 24 and the polymer structure 22 are preferably optically transparent and a refractive index match. This allows light incident on unit 10, not otherwise absorbed by the pigment particles 38, to be transmitted unhindered (i.e., not refracted or diffracted) by the interface between the suspending fluid of the electro-optic medium 24 and the polymer structure 22.

A sealing layer having, e.g., a polymeric composition, may be applied over the polymer structure 22 to seal the electro-optic medium 24 in the plurality of cells 30. The pillar structures 34 provide structural support and sealing adhesion to the sealing layer.

Additionally, one or more layers of adhesive, such as an optically-clear adhesive available, e.g., from Norland, may be used to bond various films and structures to one another.

FIGS. 3A and 3B illustrate a light modulator 449 with an alternate polymer structure design as disclosed in U.S. Patent No. 10,067,398. FIG. 3A shows a cross-section view of the light modulator 449, and FIG. 3B shows a top plan view of the polymer structure 158 in the light modulator 449. The polymer structure 158 is non-planar and comprises protrusions 795 whose extent coincides with channels 101 and cavities 488.

FIGS. 3A and 3B show the light modulator 449 in an open state. Black charged particles 11 are deflected by (or move over) the surface of protrusions 795 in an electrical field and concentrate in the interstices of protrusions 795 forming apertures 1006. The non-planar, polymer structure 158 has aperiodically arranged protrusions 795 in electrophoretic cell 614. The surface shape, cross-sectional area, cross-sectional geometric form, and orientation of its protrusions 795 are different from each other and can be random or possess a degree of randomness. Protrusions of the type 795 are asymmetrical and have facets with different areas and slopes to enhance the randomness of the apertures 1006 defined by the protrusions in light states. Light encountering embodiment 449 diffracts randomly and avoids the perception of a diffraction pattern about a bright light source viewed through the device.

Channels 101 coincide with the interstices of protrusions 795 and hold concentrated, black, charged particles 11 in the open state. The channels 101 are recesses in the non-planar, polymer structure 158 and are at least partly below the level of the protrusions 795 as shown in FIG. 3A. The concentrated black, charged particles can fill a volume in the interstices of protrusions proportional to the particle loading in the electrophoretic ink (e.g., a particle loading in the range 5% to 30% by mass of the ink). In viewing the face of the device in the open state, the concentrated particles form light absorbing areas (i.e., obstructions) that limit the maximum light transmittance. The channels 101 minimize the face area covered by concentrated, black, charged particles 11 in the open state by concentrating (or stacking) the particles in the z-axis of the cell 614.

In light modulator 449, each protrusion 795 is closely surrounded by its channel 101 and a polymer wall 76 and their extent define an electrophoretic ink cavity 488. In the FIG. 3B view, the black mask 606 covering polymer walls 76 is in peripheral areas of the apertures (i.e., it does not form part of an aperture’s circumference) in the second light state with wall edges adjacent concentrated black particles 11 as shown by light obstruction dimension 1004. Advantageously, the black mask 606 covering walls 76 does not diffract light because along its circumference (in a face view), it does not coincide with a light transmitting area. In an alternate design, the channel 101 is absent and black charged particles 11 concentrate in the volume between the protrusion 795 and its surrounding wall 76 and adjacent the bottom electrode 60. More generally, the polymer wall sections (or lengths in the face view) coincide with peripheral areas of protrusions so that in the open state, concentrated black charged particles are adjacent to an edge of the wall section.

The non-planar, polymer structure 158 is continuous in the cell 614 and isolates the electrophoretic ink layer 613 from the bottom electrode 60. Both the discrete apertures 1006 and the continuous light obstructing area 1004, i.e., the concentrated black charged particles area and the black mask area, are random, or possess a degree of randomness. To minimize or avoid the perception of a diffraction pattern arising from the black mask 606 on polymer walls 76, the arrangement of the polymer walls and the cavities 488 they form, are aperiodic.

In other light modulators related to light modulator unit 449, the cavities, polymer walls and channels coincide with the extent of more than one microstructure. For example, each electrophoretic ink cavity, defined by its surrounding polymer walls 76, contains two or more protrusions with part of their extent coinciding with the walls, and each protrusion is surrounded by a channel.

The non-planar polymer structure 158 in device 449 is derived from a photosensitive polymer (cured photoresist) exposed by a laser beam or electron beam (e-beam) and developed to reveal the surface of microstructures. Preferably each microstructure is independently written, asymmetrical, and randomly orientated. More preferably, the parameters that define each are uncorrelated, and the close-packing of microstructures and cavities has random centers.

The size of apertures and obstructions can be maximized to minimize their total circumference per square unit of face area. The upper limit is determined by the resolution of a typical viewer’s eye. Preferably apertures and obstructions are sufficiently small so that their geometric form in a face view is not apparent. In devices where the microstructures are protrusions and the black charged particles form discrete apertures in the open state, the maximum angle subtended by an aperture to a viewer at a required viewing distance is one arcminute (corresponding to 290 microns at a viewing distance of 1 meter) and preferably 0.6 arcminutes (corresponding to 174.5 microns at 1 meter). The subtended angle of the aperture pitch (i.e. aperture and concentrated charged particle area) is double these limits. In devices where the microstructures are recesses and the black charged particles form discrete obstructions in the second light state, the maximum angle subtended by an obstruction to a viewer at a required viewing distance is one arcminute (corresponding to about 290 microns at a viewing distance of 1 meter) and preferably 0.6 arcminutes (corresponding to about 174.5 microns at 1 meter). The subtended angle of the obstruction pitch (i.e. obstruction and light transmitting area) is double these limits.

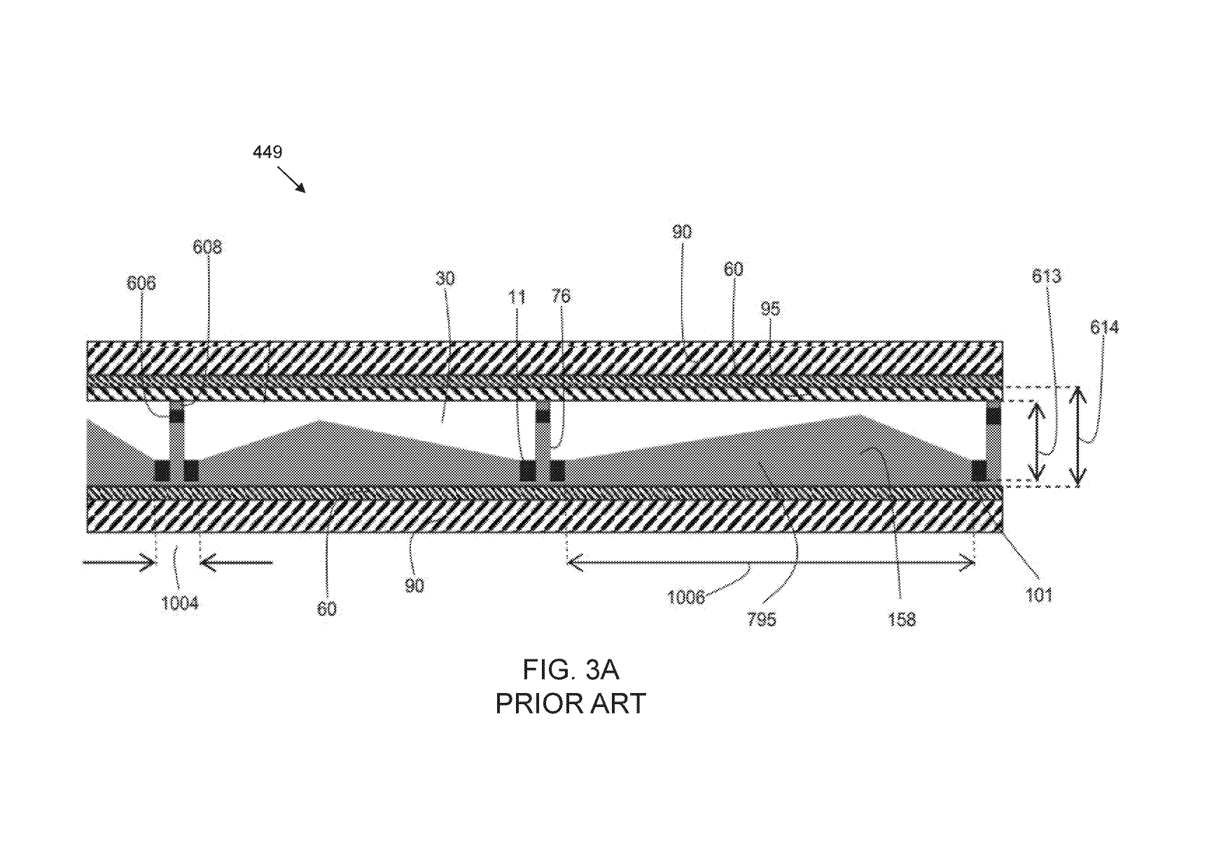

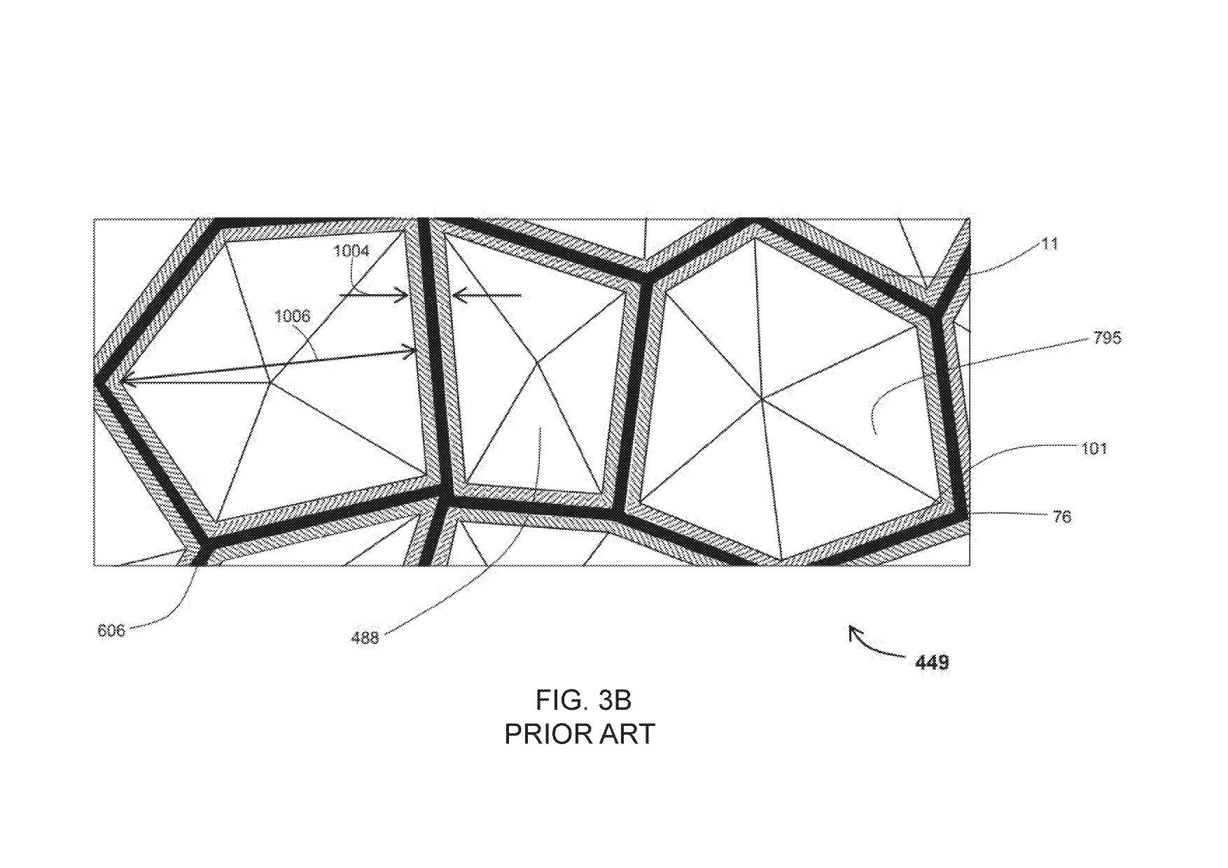

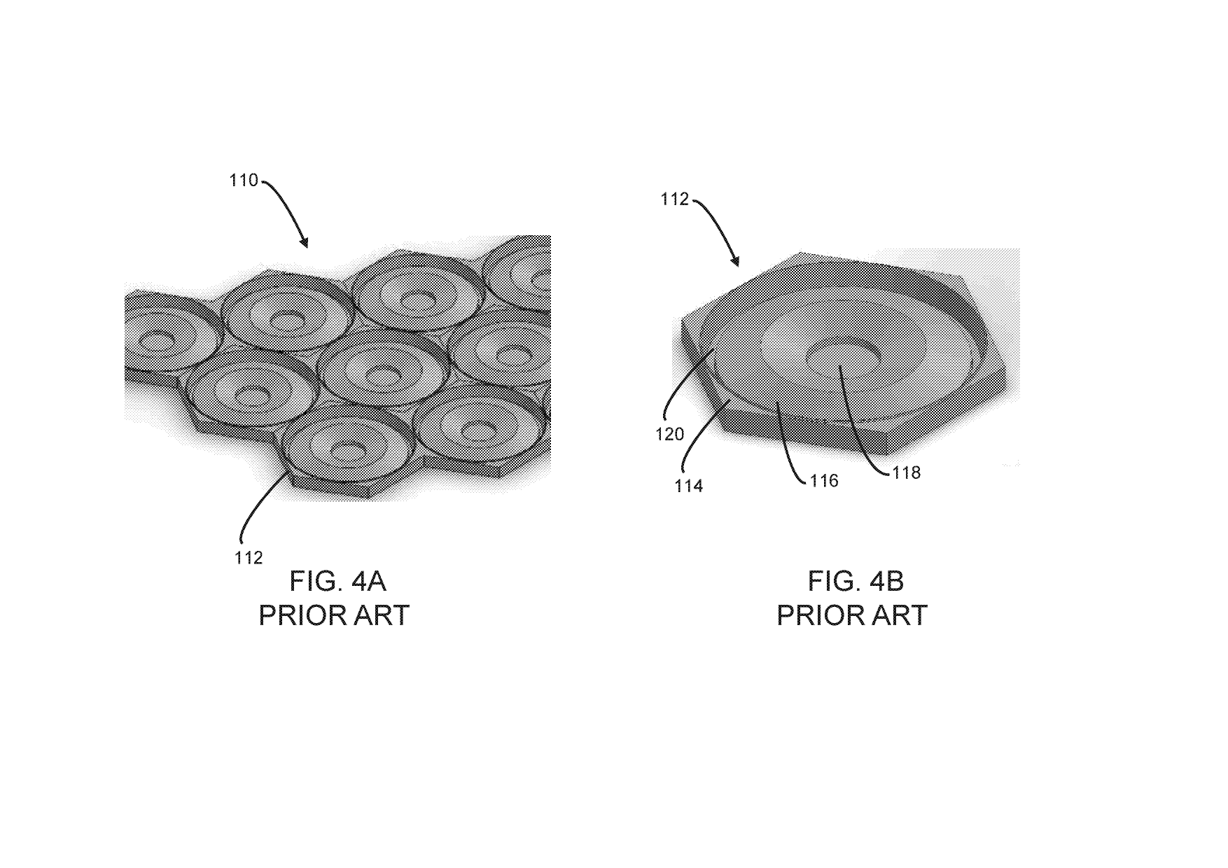

FIG. 4A is a perspective view of a portion of another example of a prior art polymer structure 110 forming part of an electrophoretic ink layer of a switchable light modulator. The polymer structure 110 includes walls 114 defining a plurality of cells 112. FIG. 4B is an enlarged view of one of the cells 112 of the polymer structure 110. Each of the cells 114 includes a protrusion 116. In this example, the protrusions 116 have a toroidal shape, defining a center well 118 and an annular well 120 extending around each protrusion 116 for collecting pigment particles.

### Switchable Light Modulator for Light Attenuation and Heat Management

A switchable light modulator is disclosed for use in a window of an enclosure such as, e.g., a greenhouse or other building or a vehicle for light attenuation and heat management.

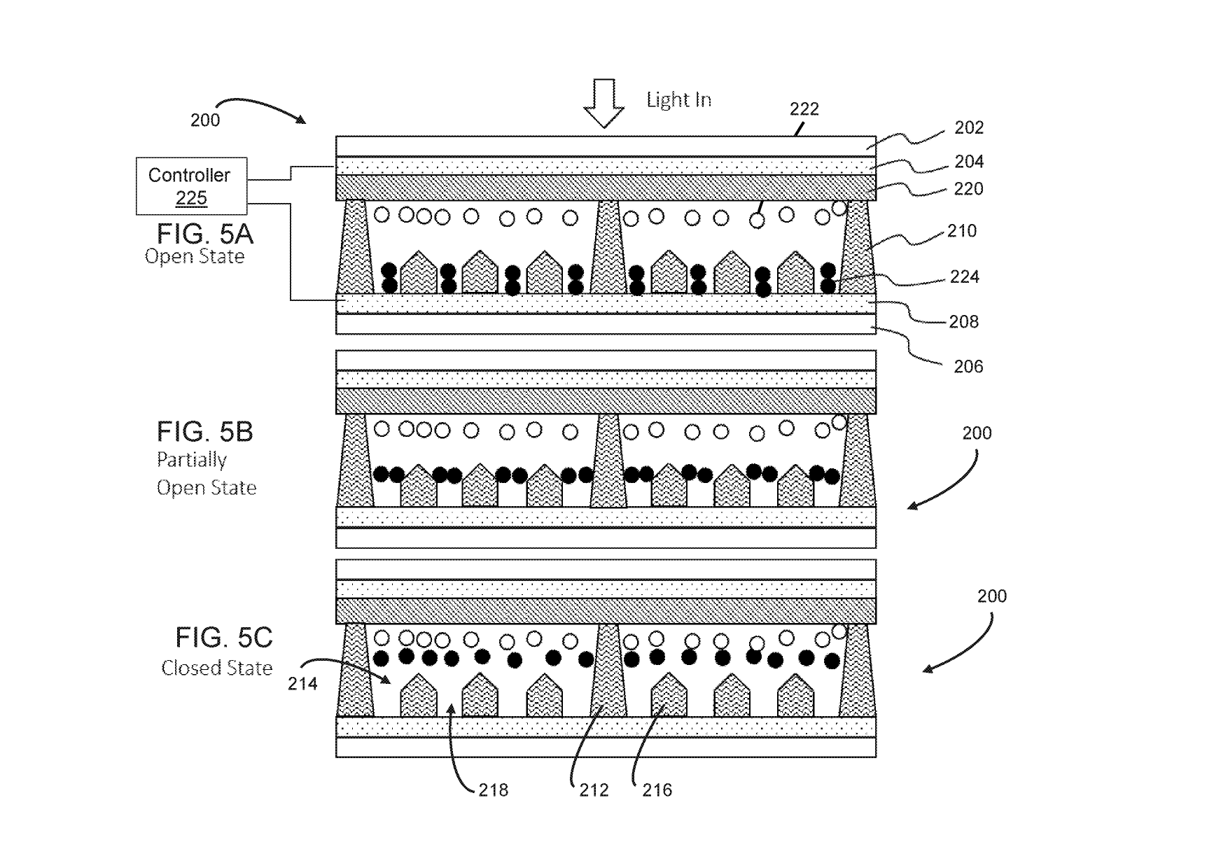

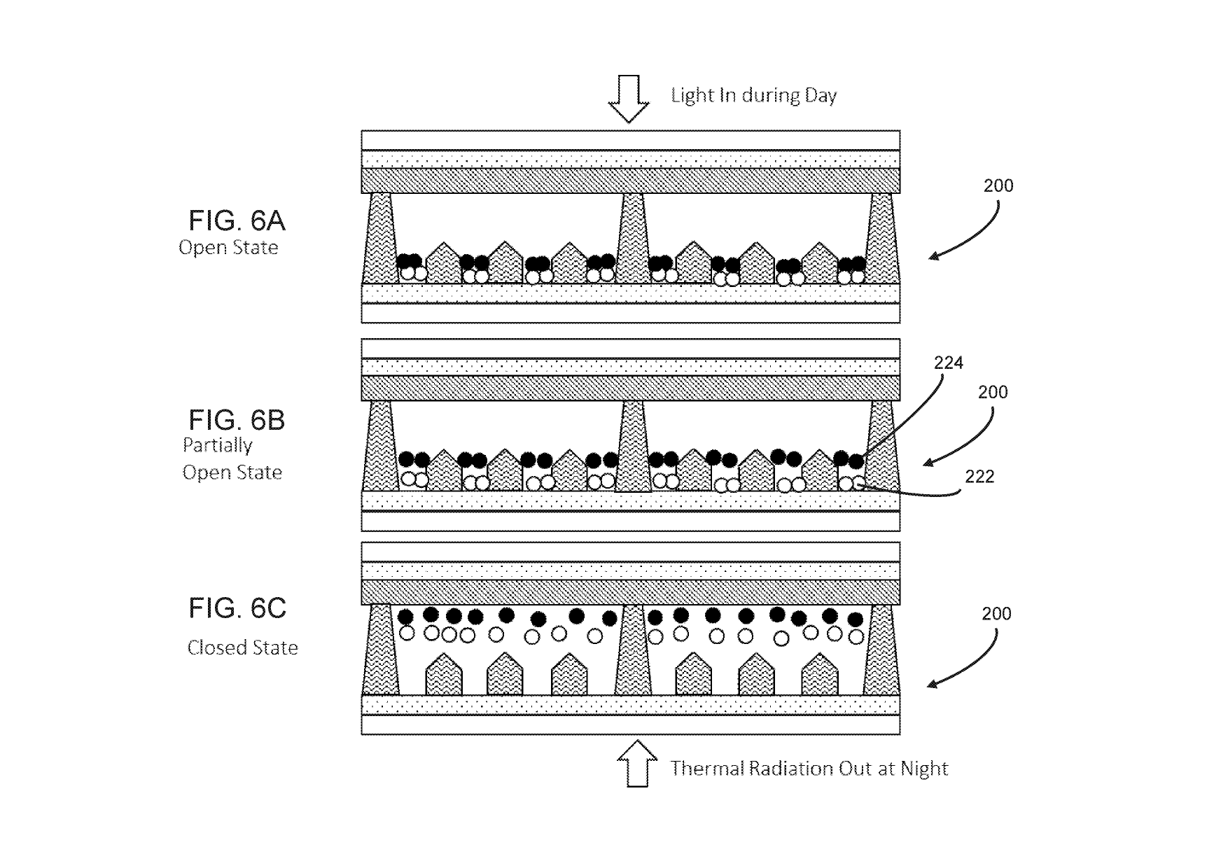

FIGS. 5A-5C and 6A-6C are simplified drawings showing a portion of an exemplary switchable light modulator 200 according to one aspect of the invention in various modes of operation. As shown, the switchable light modulator 200 includes a first light-transmissive substrate 202 for receiving incident sunlight, a first electrode layer 204 on one side of the first light-transmissive substrate 202, a second light-transmissive substrate 206 facing the interior space (of the building, vehicle, or other enclosure), and a second electrode layer 208 on one side of the second light-transmissive substrate 206. A light-transmissive polymer structure 210 is disposed between the first electrode layer 204 and the second electrode layer 208. In one or more embodiments, the light-transmissive polymer structure 210 is similar to the polymer structures described above in FIGS. 2-4. The polymer structure 210 includes walls 212 defining a plurality of cells 214. Each of the cells 214 includes a plurality of protrusions 216 and wells 218 therebetween. In one or more embodiments, the protrusions 216 are pyramidal or conical-shaped and the wells 218 have an annular shape and encircle the protrusions 216. In one or more embodiments, the wells 218 comprise recesses surrounded by the protrusions 216. In general, the wells can comprise any recessed space in the polymer structure 210 suitable for collecting pigment particles, including channels, cavities, openings, etc.

An electrophoretic medium is contained in each of the plurality of cells 214. The cells 214 are enclosed with a sealant layer 220. The electrophoretic medium comprises a plurality of charged reflective pigment particles 222 and a plurality of charged absorptive pigment particles 224 dispersed in a non-polar solvent.

The switchable light modulator 200 also includes a controller 225, which is coupled to and configured to apply a set of driving voltages between the first and second electrodes 204, 208 to drive the electrophoretic medium among a plurality of different optical states corresponding to various modes of operation, as discussed below. The controller 225 may comprise one or more processors and memories and/or one or more programmable hardware elements and is intended to include any types of processors, CPUs, microcontrollers, digital signal processors, or other devices capable of executing software instructions. In some embodiments, the controller 225 is a component of the switchable light modulator 200. In some embodiments, the controller is remotely located and communicates the driving voltages to the switchable light modulator.

As shown in FIGS. 5A-5C, the switchable light modulator 200 can be switched among a first set of optical states configured to reduce indoor heating induced by incident sunlight. The switchable light modulator 200 reduces transmittance of thermal radiation from the incident sunlight into the interior space by spreading the plurality of charged reflective pigment particles 222 across each cell proximate the first electrode layer 204. In one or more embodiments, the charged reflective pigment particles 222 in this arrangement reflect about 20 to 60% of the incident sunlight (including its ultraviolet (UV), visible, and infrared (IR) components). The charged absorptive pigment particles 224 are positioned between the charged reflective pigment particles 222 and the second electrode layer 208 in varying arrangements to achieve open, tinted, and closed states.

In the open state depicted in FIG. 5A, the charged absorptive pigment particles 224 are concentrated in the wells 218 in the polymer structure 210 to increase or generally maximize transmittance of visible light from the incident sunlight through the switchable light modulator 200. As noted above, the charged reflective pigment particles 222 are distributed across each cell to reduce transmittance of thermal (primarily IR) radiation from the incident sunlight through the switchable light modulator 200.

In the tinted state depicted in FIG. 5B, the charged absorptive pigment particles 224 are positioned in or proximate to the wells 218 in the polymer structure 210 in a less concentrated arrangement than in the first open state to partially block transmittance of visible light from the incident sunlight through the switchable light modulator 200, i.e., to block transmittance of a greater amount of visible light than the open state of FIG. 5A. As noted above, the charged reflective pigment particles 222 are distributed across each cell to reduce transmittance of thermal radiation from the incident sunlight through the switchable light modulator 200.

In the closed state depicted in FIG. 5C, the charged absorptive pigment particles 224 and the charged reflective pigment particles 222 are distributed across each cell. The charged reflective pigment particles 222 are positioned in a layer between the charged absorptive pigment particles 224 and the first electrode layer 204. Together, the charged absorptive pigment particles 224 and the charged reflective pigment particles 222 substantially block transmittance of the incident sunlight through the switchable light modulator 200.

As shown in FIGS. 6A and 6B, the switchable light modulator 200 can be switched between a second set of optical states when heating of the interior space is by sunlight is desired. The second set of optical states promotes transmittance of thermal radiation from the incident sunlight through the switchable light modulator 200 into the interior space by concentrating the plurality of charged reflective pigment particles 222 in the wells 218 in the polymer structure 210 and positioning the plurality of charged absorptive pigment particles 224 between the charged reflective pigment particles 222 and the first electrode layer 204 in varying arrangements to achieve open and tinted states.

In the open state depicted in FIG. 6A, the charged absorptive pigment particles 224 and the charged reflective pigment particles 222 are concentrated in the wells 218 in the polymer structure 210 to substantially maximize transmittance of visible light and thermal radiation from the incident sunlight through the switchable light modulator 200 into the interior space.

In the tinted state depicted in FIG. 6B, the charged absorptive pigment particles 224 are positioned in or proximate to the wells 218 in the polymer structure 210 in a less concentrated arrangement than the charged absorptive particles 224 in the FIG. 6A open state to partially block transmittance of visible light from the incident sunlight through the switchable light modulator 200. The charged reflective pigment particles 222 are concentrated in the wells 218 in the polymer structure 210 to increase transmittance of thermal radiation from the incident sunlight through the switchable light modulator 200.

As shown in FIG. 6C, the switchable light modulator 200 can be switched to a closed optical state for reducing transmittance of thermal radiation out of the interior space (e.g., during nighttime operation) by spreading the charged reflective pigment particles 222 across each cell 214 and spreading the charged absorptive pigment particles 224 across each cell 214 in a layer between the charged reflective pigment particles 222 and the first electrode layer 204.

In one or more embodiments, the charged absorptive pigment particles 224 are electrically charged black pigment particles. For example, the black pigment particles can be carbon black particles, metal oxide black particles, organic black particles, or inorganic and organic composite black particles. The black pigment particles may optionally be surface treated or polymerized, depending on particular applications. For surface treatment, a surface treatment agent can be either chemically or physically bonded to the black particle surfaces. Polymerization can be performed either on surface-treated black particles or directly on the black particles. The polymerization can be grafting polymerization, dispersion polymerization, emulsion polymerization, suspension polymerization, and other similar polymerization techniques with suitable modification.

In one or more embodiments, the charged reflective pigment particles 222 are electrically charged particles having one of various colors, e.g., white, brown, red, green, orange, yellow, violet, and purple. In one or more embodiments, the charged reflective pigment particles 222 are metal oxide particles, organic particles, or inorganic and organic composite particles. The charged reflective pigment particles 222 may optionally be surface treated or polymerized, depending on desired applications. For surface treatment, a surface treatment agent can be either chemically or physically bonded to the particle surfaces. Polymerization can be performed either on surface-treated reflective particles or directly on the reflective particle surfaces. Polymerization can be grafting polymerization, dispersion polymerization, emulsion polymerization, suspension polymerization, or other similar polymerization techniques with suitable modification. In some embodiments, the charged reflective pigment particles 222 comprise materials to increase thermal reflectivity, selected from Ag, Sn, In, Ti, Zn, Si, La, Ce, Zr, Fe, Al, Cr, Co, Ni, Cu, Pt, Rh, Mn, Ta, W, V, Mo, stainless steel, tin-doped indium oxide, antimony-doped tin oxide, antimony oxide doped tin oxide, lanthanum hexaboride, aluminium-doped zinc oxide, indium-doped zinc oxide, tin-doped zinc oxide, silicon-doped zinc oxide, fluorine-doped zinc oxide, gallium-doped zinc oxide, fluorine-doped tin oxide, cadmium tin oxide, tungsten oxide, tungsten oxide composite, cobalt oxide, chromium oxide, iron oxide, nickel oxide, titanium nitride, cerium hexaboride, B₁O₃, Ιn₂0₃, Sn0₂, Ti0₂, TiOx, Zn0₂, ZnS, Si₃N₄, Nb₂0₅, Ta₂0₅, Si0₂, and MgF₂.

The controller is configured to apply a set of driving voltages between the first and second electrodes to drive the electrophoretic medium to the various optical states discussed above. The driving voltages can include rapidly-alternating positive and negative voltage pulses and locally-sustained voltage biases, applied in succession or simultaneously, to achieve desired optical states.

In one or more embodiments, the set of driving voltages for driving the electrophoretic medium to the open state depicted in FIG. 5A include application of a negative bias to the second electrode layer 208 to push the (negatively) charged reflective pigment particles 222 toward the opposite first electrode layer 204 and to pull the (positively) charged absorptive pigment particles 224 into the wells 218. It has been found that pigment particle motion is enhanced by interrupting this negative voltage drive with positive voltage interruptions. Thus, in one or more embodiments, the set of driving voltages comprises a series of alternating positive and negative voltage pulses repeated multiple times. In one or more embodiments, the positive pulses have an amplitude of 100 V to 200 V and a pulse width of 5 to 10 ms, and the negative pulses have an amplitude of -100 to -200 V and a pulse width of 90 to 95 ms.

It has been found that improved spreading or distribution of the charged reflective pigment particles 222 can be achieved by applying high-amplitude alternating positive and negative voltage pulses. High amplitude pulses induce a flow pattern inside each cell 214 that effectively carries charged reflective pigment particles 222 out of wells 218 and distributes the particles across the cells 214. The high amplitude pulses induce a dispersing flow that increases approximately proportionately with the square of the driving voltage amplitude. A negative voltage bias is added to alternating pulses, either simultaneously in the form of a constant added negative voltage or by adjusting the duty cycle of the drive pulses off of 50:50 (50% of time positive, 50% of time negative) to a value that favors the negative voltage, such as 40:60 or 30:70, or by consecutively by switching between the alternating pulse drive and a negative voltage drive in consecutive time segments. In one or more embodiments, the series of alternating positive and negative voltage pulses has a frequency of 10 Hz to 80 Hz. In one or more embodiments, and the positive and negative voltage pulses have a reduced amplitude towards the end of the series of pulses in order to allow the charged absorptive pigment particles 224 to settle into the wells 218 without being entrained in fluid flow out of the wells 218.

By reducing the negative voltage bias during the alternating pulse drive, the partially open optical state shown in FIG. 5B can be achieved where the charged absorptive pigment particles 224 are less well settled in the wells 218. By further reducing the negative voltage bias, the closed optical state shown in FIG. 5C can be achieved where both charged reflective pigment particles and the charged absorptive pigment particles 224 are distributed or spread across the cells 214.

The open state depicted in FIG. 6A (when heating of the interior space is by sunlight is desired) can be achieved utilizing driving voltages that act on differences in threshold behavior of the charged reflective pigment particles and charged absorptive pigment particles 224 as discussed below. In one or more embodiments, the charged reflective pigment particles 222 are drawn into the wells 218 with a positive drive voltage pulse applied to the second electrode layer 208. After that, the charged absorptive pigment particles 224 are moved toward the wells 218 using a series of negative, low-amplitude voltage pulses. The amplitude and duration of the negative pulses are configured so as to not re-disperse the charged reflective pigment particles 222 out of the wells 218.

The partially open state illustrated in FIG. 6B can be achieved by first driving the electrophoretic medium to the open state (FIG. 6A) as discussed above and then applying a positive pulse to the second electrode layer 208 sufficient to push the charged absorptive pigment particles 224 modestly out of the wells 218.

The closed state illustrated in FIG. 6C can be achieved using a waveform similar to that used to achieve the closed state in FIG. 5C. The waveform to achieve the FIG. 6C optical state comprises a series of alternating positive and negative voltage pulses having a voltage bias that is positive instead of negative.

In one or more embodiments, to achieve the optical states depicted in FIGS. 5A-5C and 6A-6C, the charged absorptive pigment particles 224 and charged reflective pigment particles are configured to respond differently to elements of the driving waveforms described above.

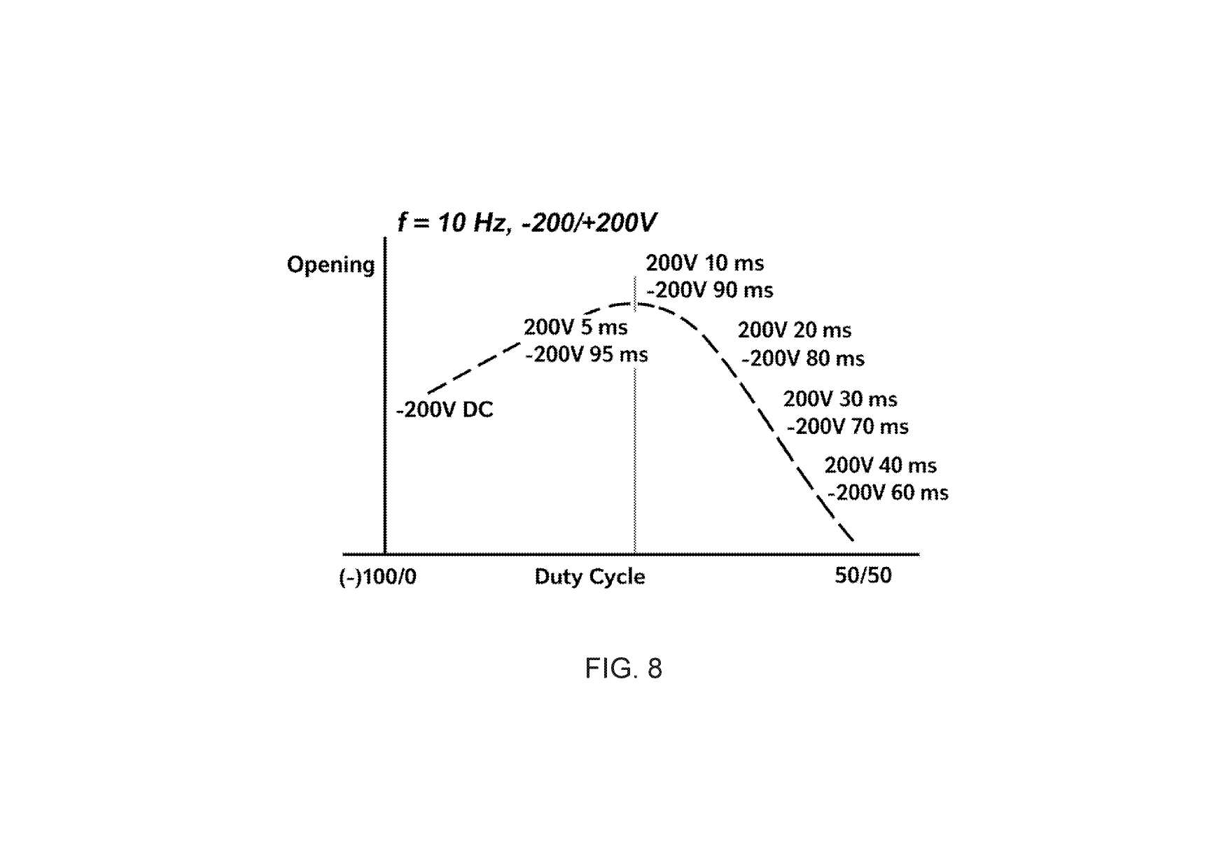

As previously noted, the charged absorptive pigment particles 224 and charged reflective pigment particles 222 have opposite charge polarity. In addition, the charged absorptive pigment particles 224 and charged reflective pigment particles 222 can be configured to move differently in response to the frequency and duty cycle of the alternating pulse drives described above. FIG. 8 is a graph illustrating one example of response characteristics of one type of charged pigment particles to drive schemes with different duty cycles. In the FIG. 8 graph, the vertical axis represents the degree of openness of an open state of a switchable light modulator 200 (indicating response characteristics of the pigment particles), and the horizontal axis represents various waveform duty cycles for a given frequency (10 Hz). The duty cycles represent the time fraction of the negative voltage pulse, from 100% on the left to 50% at the right. The waveform comprises a -200V backplane bias that is interrupted every 100ms by a +200V bias, with the positive voltage bias of various durations to achieve various duty cycles. This response curve is, in part, affected by the pigment particle characteristics. In this example, the best open state is achieved at about 5 ms positive pulse durations (duty cycle of 95%). Reduced degrees of openness occur at lower and higher positive interruption pulse durations.

A two-pigment particle system can thereby be devised where the two particle types have substantially different response characteristics. With such a paired set of pigment particles having disparate response characteristics, drive schemes with differing frequencies and duty cycles can be utilized to achieve the physical separation of the two pigment particle types to achieve the various optical states described above.

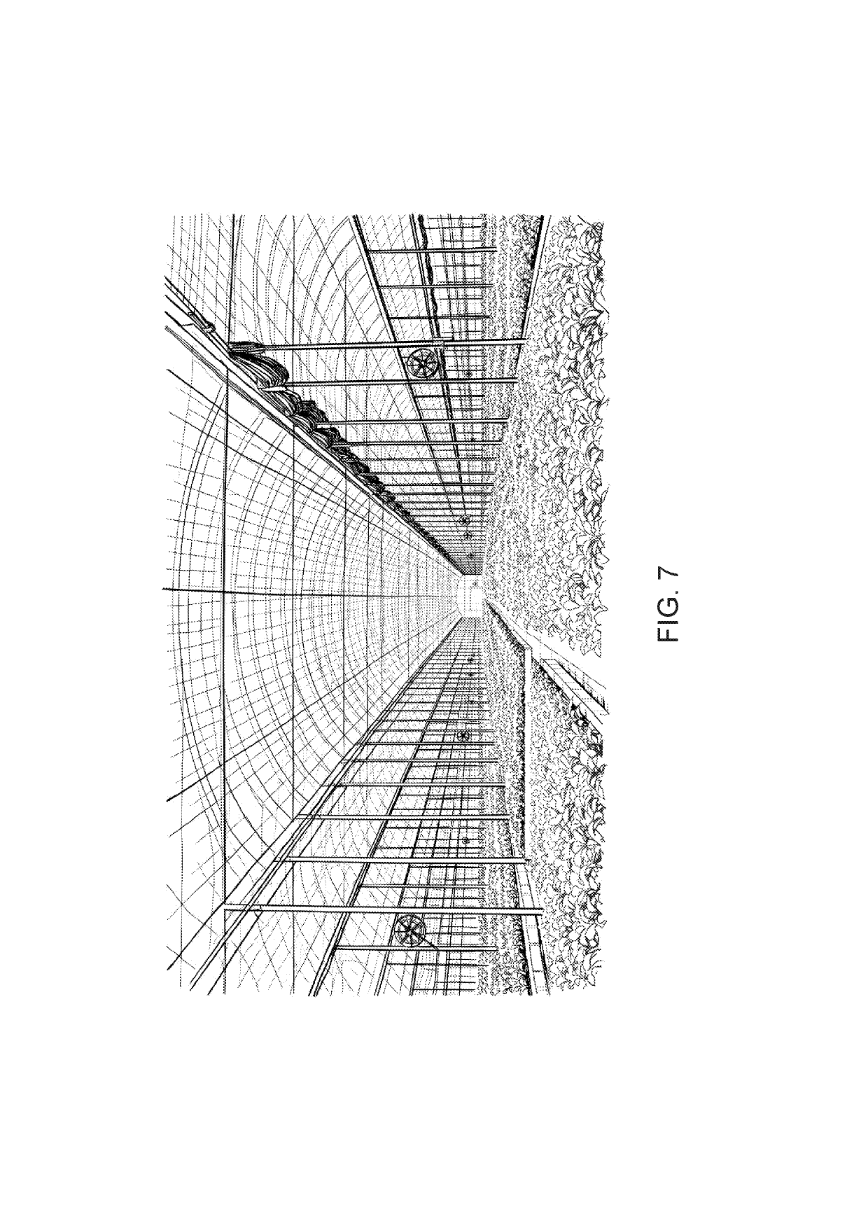

The switchable light modulators disclosed herein can have various applications. For example, a switchable light modulator in the form of a film can be used in building windows or automotive sunroofs for controlling light attenuation and managing thermal radiation. In one particular example, the switchable light modulator can be used greenhouses (e.g., as depicted in FIG. 7), where heat management is critical. Under extreme hot conditions, the switchable light modulator provides shading to reduce the amount of incoming thermal radiation. Under cold conditions, especially in areas experiencing large temperature variance between day and night conditions, the switchable light modulator provides thermal screening to reduce outgoing transmission of heat radiation to maintain internal temperatures at night.

It will be apparent to those skilled in the art that numerous changes and modifications can be made in the specific embodiments of the present invention described above without departing from the scope of the invention. Accordingly, the whole of the foregoing description is to be construed in an illustrative and not in a limitative sense.

1. A switchable light modulator for use in a window of an enclosure for light attenuation and heat management, comprising:
a first light-transmissive substrate for receiving incident sunlight;
a first electrode layer on one side of the first light-transmissive substrate;
a second light-transmissive substrate;
a second electrode layer on one side of the second light-transmissive substrate;
a light-transmissive polymer structure between the first electrode layer and the second electrode layer, the light-transmissive polymer structure including a base superposed on the second electrode layer and a wall structure extending orthogonally from the base defining a plurality of cells, each of the plurality of cells including a plurality of wells in the base;
an electrophoretic medium contained in each of the plurality of cells, said electrophoretic medium comprising a plurality of charged reflective pigment particles and a plurality of charged absorptive pigment particles dispersed in a non-polar solvent; and
a controller configured to apply a set of driving voltages between the first and second electrodes to drive the electrophoretic medium among a plurality of optical states including:
(a) a first set of optical states for reducing transmittance of thermal radiation from the incident sunlight through the switchable light modulator into the enclosure by spreading the plurality of charged reflective pigment particles across each cell proximate the first electrode layer and positioning the plurality of charged absorptive pigment particles between the plurality of charged reflective pigment particles and the second electrode layer in varying arrangements to achieve open, tinted, and closed states,
(b) a second set of optical states for promoting transmittance of thermal radiation from the incident sunlight through the switchable light modulator into the enclosure by concentrating the plurality of charged reflective pigment particles in the wells in the polymer structure and positioning the plurality of charged absorptive pigment particles between the plurality of charged reflective pigment particles and the first electrode layer in varying arrangements to achieve open and tinted states, and
(c) a third set of optical states for reducing transmittance of thermal radiation out of the enclosure during nighttime operation by spreading the plurality of charged reflective pigment particles across each cell and spreading the plurality of charged absorptive pigment particles across each cell between the plurality of charged reflective pigment particles and the first electrode layer.

2. The switchable light modulator of claim 1, wherein the first set of optical states includes:
(i) a first open state, in which the plurality of charged absorptive particles are concentrated in the wells in the polymer structure to increase transmittance of visible light from the incident sunlight through the switchable light modulator, and the plurality of charged reflective pigment particles are distributed across each cell proximate the first electrode layer to reduce transmittance of thermal radiation from the incident sunlight through the switchable light modulator,
(ii) a first tinted state, in which the plurality of charged absorptive particles are positioned in or proximate to the wells in the polymer structure in a less concentrated arrangement than the charged absorptive particles in the first open state to partially block transmittance of visible light from the incident sunlight through the switchable light modulator, and the plurality of charged reflective pigment particles are distributed across each cell proximate the first electrode layer to reduce transmittance of thermal radiation from the incident sunlight through the switchable light modulator, and
(iii) a first closed state, in which the plurality of charged absorptive particles and the plurality of charged reflective pigment particles are distributed across each cell, with the layer of the plurality of charged reflective pigment particles positioned between the layer of the plurality of charged absorptive particles and the first electrode layer, to reduce transmittance of the incident sunlight through the switchable light modulator.

3. The switchable light modulator of claim 1, wherein the second set of optical states includes:
(i) a second open state, in which the plurality of charged absorptive particles and the plurality of charged reflective pigment particles are concentrated in the wells in the polymer structure to increase transmittance of visible light and thermal radiation from the incident sunlight through the switchable light modulator, and
(ii) a second tinted state, in which the plurality of charged absorptive particles are positioned in or proximate to the wells in the polymer structure in a less concentrated arrangement than the charged absorptive particles in the second open state to partially block transmittance of visible light from the incident sunlight through the switchable light modulator, and the plurality of charged reflective pigment particles are concentrated in the wells in the polymer structure to increase transmittance of thermal radiation from the incident sunlight through the switchable light modulator.

4. The switchable light modulator of claim 1, wherein the third set of optical states includes a second closed state, in which a layer of the plurality of charged absorptive particles and a layer of the plurality of charged reflective pigment particles are distributed across each cell, with the layer of the plurality of charged absorptive particles positioned between the layer of the plurality of charged reflective pigment particles and the first electrode layer, to reduce transmittance of thermal radiation out of the enclosure through the switchable light modulator.

5. The switchable light modulator of claim 1, wherein the plurality of charged reflective pigment particles can be arranged in the cells to reflect 20–60% of the incident sunlight.

6. The switchable light modulator of claim 1, wherein the enclosure comprises a building, a greenhouse, or a vehicle, or wherein the switchable light modulator comprises a film superposed on the window.

7. The switchable light modulator of claim 1, wherein
the charged absorptive pigment particles are black or wherein the charged reflective pigment particles are white, brown, red, green, orange, yellow, violet, or purple.

8. The switchable light modulator of claim 1, wherein
the base of the light-transmissive polymer structure includes a plurality of pyramidal or conical-shaped features, each surrounded by an annular well.

9. The switchable light modulator of claim 1, wherein
the set of driving voltages for driving the electrophoretic medium to one of the first set of optical states comprises a series of alternating positive and negative voltage pulses repeated a plurality of times, the positive pulses having an amplitude of 100 V to 200 V and a pulse width of 5 to10 ms, and the negative pulses having an amplitude of -100 to -200 V and a pulse width of 90 to 95 ms.

10. The switchable light modulator of claim 1, wherein
the set of driving voltages for driving the electrophoretic medium to one of the first set of optical states comprises a series of alternating positive and negative voltage pulses repeated a plurality of times with a negative bias voltage, wherein the series of alternating positive and negative voltage pulses has a frequency of 10 Hz to 80 Hz, and wherein the positive and negative voltage pulses decrease in amplitude from the beginning to the end of the series of pulses.

11. The switchable light modulator of claim 1, wherein
the set of driving voltages to drive the electrophoretic medium to an open state of the second set of optical states comprises a positive drive voltage pulse to draw the charged reflective pigment particles into the wells followed by a series of negative, low-amplitude voltage pulses to draw the charged absorptive pigment particles into the wells such that the charged reflective pigment particles are positioned between the charged absorptive pigment particles and the second electrode layer.

12. The switchable light modulator of claim 1, wherein
the set of driving voltages to drive the electrophoretic medium to a tinted state of the second set of optical states comprises a positive drive voltage pulse to draw the charged reflective pigment particles into the wells followed by a series of negative, low-amplitude voltage pulses to draw the charged absorptive pigment particles into the wells such that the charged reflective pigment particles are positioned between the charged absorptive pigment particles and the second electrode layer, followed by a positive voltage pulse to push some, but not all of the charged absorptive pigment particles out of the wells.

13. A method comprising:
providing a switchable light modulator for use in a window of an enclosure for light attenuation and heat management, comprising a first light-transmissive substrate for receiving incident sunlight;
a first electrode layer on one side of the first light-transmissive substrate;
a second light-transmissive substrate;
a second electrode layer on one side of the second light-transmissive substrate;
a light-transmissive polymer structure between the first electrode layer and the second electrode layer, the light-transmissive polymer structure including a base superposed on the second electrode layer and a wall structure extending orthogonally from the base defining a plurality of cells, each of the plurality of cells including a plurality of wells in the base; and an electrophoretic medium contained in each of the plurality of cells, said electrophoretic medium comprising a plurality of charged reflective pigment particles and a plurality of charged absorptive pigment particles dispersed in a non-polar solvent;
applying a set of driving voltages between the first and second electrodes to drive the electrophoretic medium among a plurality of optical states including:
(a) a first set of optical states for reducing transmittance of thermal radiation from the incident sunlight through the switchable light modulator into the enclosure by distributing the plurality of charged reflective pigment particles across each cell proximate the first electrode layer and positioning the plurality of charged absorptive pigment particles between the plurality of charged reflective pigment particles and the second electrode layer in varying arrangements to achieve open, tinted, and closed states,
(b) a second set of optical states for promoting transmittance of thermal radiation from the incident sunlight through the switchable light modulator into the enclosure by concentrating the plurality of charged reflective pigment particles in the wells in the polymer structure and positioning the plurality of charged absorptive pigment particles between the plurality of charged reflective pigment particles and the first electrode layer in varying arrangements to achieve open and tinted states, and
(c) a third set of optical states for reducing transmittance of thermal radiation out of the enclosure during nighttime by distributing the plurality of charged reflective pigment particles across each cell and positioning the plurality of charged absorptive pigment particles between the plurality of charged reflective pigment particles and the first electrode layer.

14. The method of claim 13, wherein the first set of optical states includes:
(i) a first open state, in which the plurality of charged absorptive particles are concentrated in the wells in the polymer structure to increase transmittance of visible light from the incident sunlight through the switchable light modulator, and the plurality of charged reflective pigment particles are distributed across each cell proximate the first electrode layer to reduce transmittance of thermal radiation from the incident sunlight through the switchable light modulator,
(ii) a first tinted state, in which the plurality of charged absorptive particles are positioned in or proximate to the wells in the polymer structure in a less concentrated arrangement than the charged absorptive particles in the first open state to partially block transmittance of visible light from the incident sunlight through the switchable light modulator, and the plurality of charged reflective pigment particles are distributed across each cell proximate the first electrode layer to reduce transmittance of thermal radiation from the incident sunlight through the switchable light modulator, and
(iii) a first closed state, in which the plurality of charged absorptive particles and the plurality of charged reflective pigment particles are distributed across each cell, with the layer of the plurality of charged reflective pigment particles positioned between the layer of the plurality of charged absorptive particles and the first electrode layer, to reduce transmittance of the incident sunlight through the switchable light modulator.

15. The method of claim 13, wherein the second set of optical states includes:
(i) a second open state, in which the plurality of charged absorptive particles and the plurality of charged reflective pigment particles are concentrated in the wells in the polymer structure to increase transmittance of visible light and thermal radiation from the incident sunlight through the switchable light modulator, and
(ii) a second tinted state, in which the plurality of charged absorptive particles are positioned in or proximate to the wells in the polymer structure in a less concentrated arrangement than the charged absorptive particles in the second open state to partially block transmittance of visible light from the incident sunlight through the switchable light modulator, and the plurality of charged reflective pigment particles are concentrated in the wells in the polymer structure to increase transmittance of thermal radiation from the incident sunlight through the switchable light modulator.

16. The method of claim 13, wherein the third set of optical states includes a second closed state, in which a layer of the plurality of charged absorptive particles and a layer of the plurality of charged reflective pigment particles are distributed across each cell, with the layer of the plurality of charged absorptive particles positioned between the layer of the plurality of charged reflective pigment particles and the first electrode layer, to reduce transmittance of thermal radiation out of the enclosure through the switchable light modulator.

17. The method of claim 13, wherein the charged absorptive pigment particles are black or wherein the charged reflective pigment particles are white, brown, red, green, orange, yellow, violet, or purple.

18. The method of claim 13, wherein the set of driving voltages to drive the electrophoretic medium to one of the first set of optical states comprises a series of alternating positive and negative voltage pulses repeated a plurality of times, the positive pulses having an amplitude of 100 V to 200 V and a pulse width of 5 to 10 ms, and the negative pulses having an amplitude of -100 to -200 V and a pulse width of 90 to 95 ms.

19. The method of claim 13, wherein the set of driving voltages to drive the electrophoretic medium to one of the first set of optical states comprises a series of alternating positive and negative voltage pulses repeated a plurality of times with a negative bias voltage, wherein the series of alternating positive and negative voltage pulses has a frequency of 10 Hz to 80 Hz, and wherein the positive and negative voltage pulses decrease in amplitude from the beginning to the end of the series of pulses.

20. The method of claim 13, wherein the set of driving voltages to drive the electrophoretic medium to an open state of the second set of optical states comprises a positive drive voltage pulse to draw the charged reflective pigment particles into the wells followed by a series of negative, low-amplitude voltage pulses to draw the charged absorptive pigment particles into the wells such that the charged reflective pigment particles are positioned between the charged absorptive pigment particles and the second electrode layer, or wherein the set of driving voltages to drive the electrophoretic medium to a tinted state of the second set of optical states comprises a positive drive voltage pulse to draw the charged reflective pigment particles into the wells followed by a series of negative, low-amplitude voltage pulses to draw the charged absorptive pigment particles into the wells such that the charged reflective pigment particles are positioned between the charged absorptive pigment particles and the second electrode layer, followed by a positive voltage pulse to push some, but not all of the charged absorptive pigment particles out of the wells.
